(19) United States
(12) Patent Application Publication
(10) Pub. No.: US 2009/0304488 A1
(43) Pub. Date: Dec. 10, 2009

(54) Engine Filter Lifting Device

(75) Inventors: James D. Becker, Livonia, MI (US); James E. Jirele, Owatonna, MN (US); Joseph A. Frontera, Macomb, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation, Charlotte, NC (US)

(21) Appl. No.: 12/134,433

(22) Filed: Jun. 6, 2008

(51) Int. Cl. B66C 1/42

(52) U.S. Cl. 414/739

(57) ABSTRACT

A lifting device for raising and lowering a component of a vehicle for maintenance is provided. The lifting device includes a base with a plurality of legs, a fixed support arm attached to the base, a movable support arm rotatably attached to the fixed support arm, a device attached to the fixed and movable support arms, such as a long arm jack, to raise and lower the movable support arm, and an articulated gripper attached to an end of the movable support arm.

### FIELD OF THE INVENTION

The present invention relates generally to lifting equipment. More particularly, the present invention relates to a lifting device for raising and lowering a component of a vehicle for maintenance, such as, for example, a diesel particulate filter.

### BACKGROUND OF THE INVENTION

Many large vehicles and locomotives, produced by various manufacturers, such as, for example, International, Freightliner, Detroit Diesel, Volvo, Mack, GMC Medium Duty, Mitsubishi Fuso, etc., are powered by large diesel engines. Additionally, large diesel engines may be used for marine propulsion, for power generation on land or at sea, etc. These diesel engines require filters to remove particulate matter (or soot) from the exhaust gas, and a vehicle equipped with a properly-functioning diesel particulate filter (or DPF) generally does not emit visible smoke as exhaust. While many different filter technologies are available, such as, for example, ceramic wall flow filters, silicon carbide wall flow filters, metal fiber flow-through filters, most non-regenerative diesel particulate filters require periodic maintenance and replacement. For example, engine oil ash tends to build up on the surfaces of the filter which eventually clogs the pores of the filter, thereby increasing the pressure drop and reducing the performance of the filter.

Many diesel particulate filters are housed within a large, cylindrical metal container, and vary greatly in dimension and weight, typically based upon the size of the engine. A small, diesel particulate filter for an on-highway application may vary between 6 and 12 inches in diameter, 12 inches to 34 inches in length, and, depending upon the filter technology, between 30 lbs to 60 lbs (or more) in weight. Other applications, such as off-road vehicles, locomotives, stationary power generators, etc., may require larger and heavier filters. Accordingly, many diesel particulate filters are difficult to remove and install by individual technicians, due to their size, weight, orientation, installation location, etc. Conventional floor cranes and lifts do not have the range, adjustability, maneuverability and safety features in this regard, and a device specifically tailored to reach, secure and safely remove large, heavy and expensive diesel particulate filters, and preferably one that is operable by a single technician, is needed.

### SUMMARY OF THE INVENTION

Embodiments of the present invention provide an apparatus for raising and lowering a component of a vehicle for maintenance.

In one embodiment, the apparatus includes a base, a plurality of legs attached thereto, a fixed support arm attached to the base, a movable support arm rotatably attached to the fixed support arm, a long arm jack, attached to the fixed support arm and the movable support arm, and an articulated gripper attached to an end of the movable support arm. In this embodiment, the articulated gripper includes a first member, a second member attached to the first member via a first hinge, a third member, attached to the second member via a second hinge, the third member including two opposing arms, each arm having a rotatable pad attached thereto via respective third hinges, and a clamping member to secure the component to the pads.

In another embodiment, the apparatus includes a frame having a base, a plurality of legs attached thereto, a fixed support arm attached to the base, a movable support arm rotatably attached to the fixed support arm, a means for raising and lowering the movable support arm, attached to the fixed support arm and the movable support arm, and a means for gripping the component, attached to an end of the movable support arm, having three rotational degrees of freedom.

In another embodiment of the present invention, an articulated gripper is provided. In this embodiment, the articulated gripper includes a first member, a second member attached to the first member via a first hinge, a third member, and a clamping member. The third member includes a support segment attached to the second member via a second hinge, and a pair of movable arm segments, attached to respective ends of the support segment, each arm segment having a rotatable pad attached thereto via respective third hinges.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 depicts a perspective view of a lifting device, in accordance with an embodiment of the present invention.

FIG. 2 depicts a right side view of a lifting device, in accordance with an embodiment of the present invention.

FIG. 3 depicts a left side view of a lifting device, in accordance with an embodiment of the present invention.

FIG. 4 depicts a top view of a lifting device, in accordance with an embodiment of the present invention.

FIGS. 5A, 5B and 5C depict several close up views of the lifting device of FIGS. 2 and 3, in accordance with an embodiment of the present invention.

FIG. 6 depicts a perspective view of a lifting device in a raised position, in accordance with an embodiment of the present invention.

FIG. 7 depicts a perspective view of a lifting device in a lowered position, in accordance with an embodiment of the present invention.

### DETAILED DESCRIPTION

Embodiments of the present invention provide a lifting device for raising and lowering a component of a vehicle for maintenance, such as, for example, a diesel particulate filter.

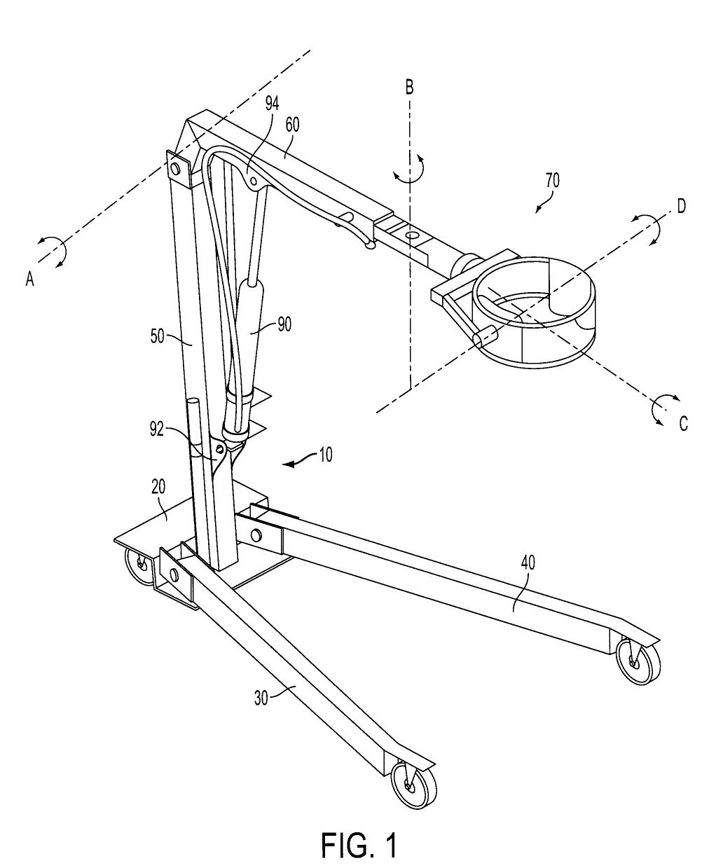

FIG. 1 presents a perspective view of lifting device 10 in accordance with an embodiment of the present invention. Lifting device 10 includes a base 20, a pair of support legs 30, 40, respectively attached to support plate 20, a fixed support arm 50 attached to base 20, a movable support arm 60 attached to fixed support arm 50, and an articulated gripper 70 attached to movable support arm 60. In the depicted embodiment, a long ram hydraulic jack 90 is attached to fixed support arm 50 and movable support arm 60, using hinges 92, 94, to provide the lifting force necessary to raise the component for installation on the vehicle, as well as the braking force necessary to lower the component after removal from the vehicle. Movable support arm 60 rotates about an axis A, perpendicular to the fixed support arm 50, to raise and lower the articulated gripper 70, while the articulated gripper 70 includes three degrees of rotational freedom about axes B, C and D. The various components of lifting device 10 may be made of steel; alternatively, other high-strength materials, such as high-strength aluminum, composites, etc., or combinations of these materials, may be used.

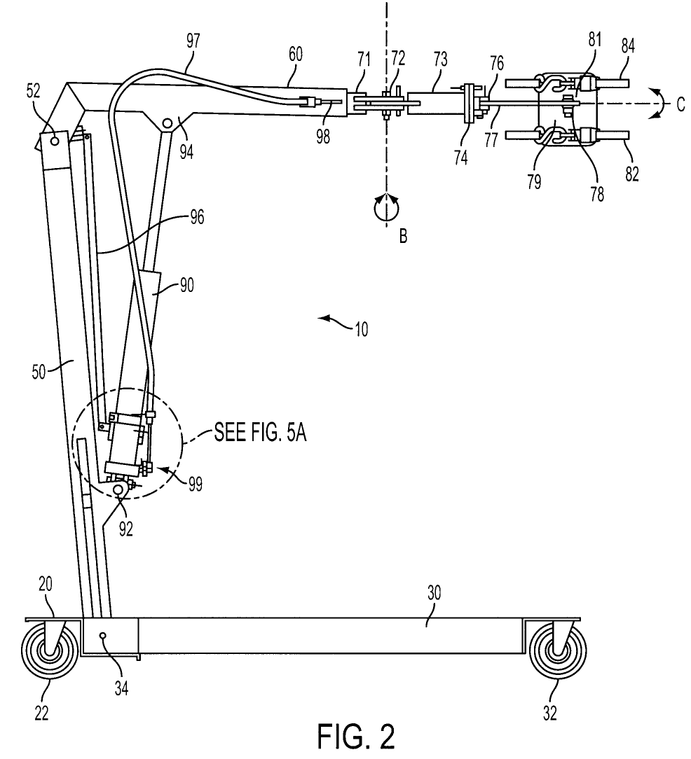

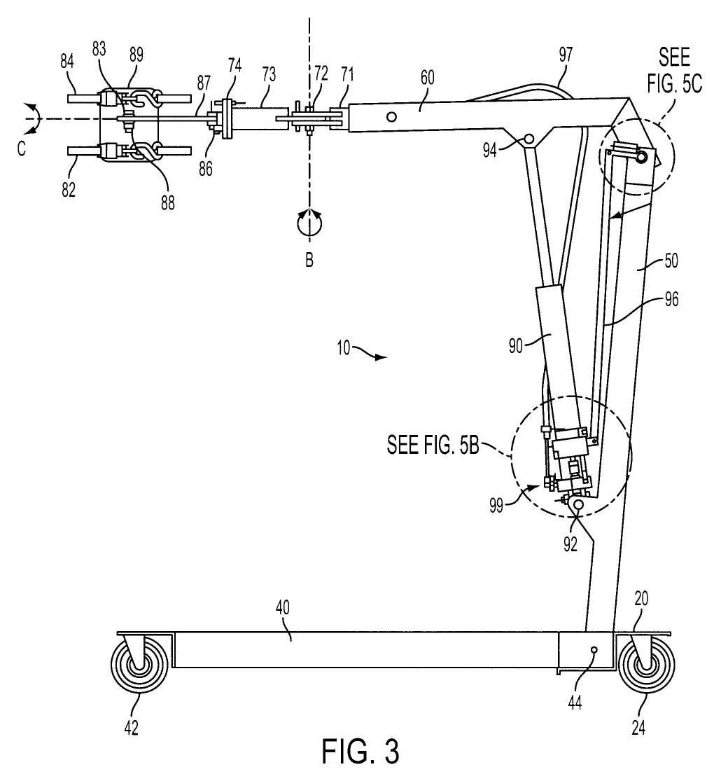

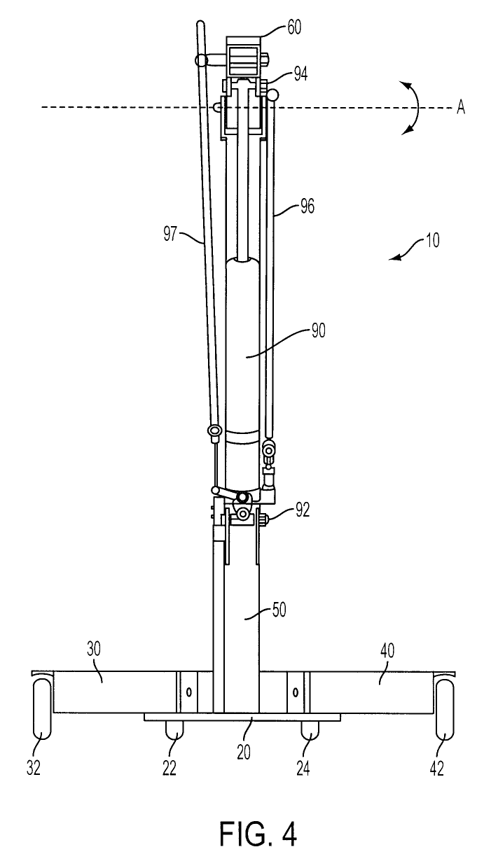

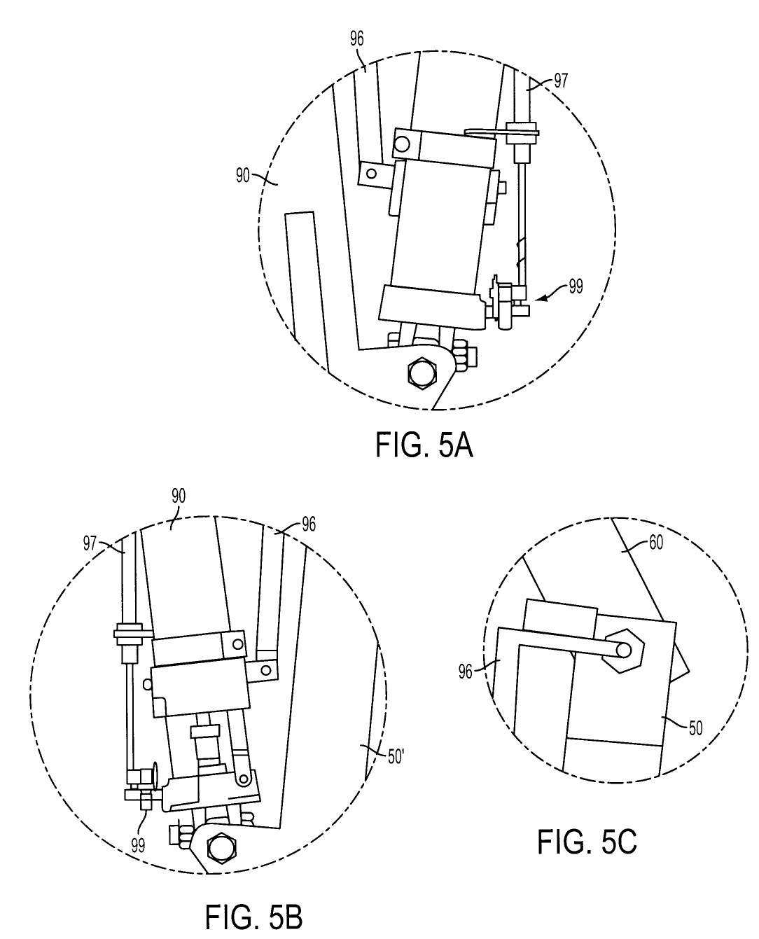

FIGS. 2-4 depict left, right and front views of lifting device 10, while FIGS. 5A, 5B and 5C illustrate close up views A, B and C (respectively) of various portions of lifting device 10 depicted in FIGS. 2 and 3, according to embodiments of the present invention.

To provide maneuverability for lifting device 10, in one embodiment, wheels 22, 24 are located on base 20, and wheels 32, 42 are located on the distal ends of legs 30, 40, respectively. While wheels 22, 24, 32, 42 are preferably swivel casters, other alternatives are contemplated by the present invention, such as, for example, a pair of fixed wheels 32, 42 combined with a single, steerable wheel 22, etc. In one embodiment, legs 30, 40 may be fixedly attached to base 20, while in other embodiments, legs 30, 40 may be movably, or removably, attached to base 20. For example, to provide a reduced footprint for storage of lifting device 10, legs 30, 40 may be movably attached to base 20 using hinges 34, 44 (respectively). Pins then secure legs 30, 40 to base 20 in either a horizontal position (as depicted in FIG. 1) or a vertical position (not shown). Alternatively, legs 30, 40 may be removably attached to base 20 using cooperative components secured by pins, bolts, threads, etc.

Long ram hydraulic jack 90 may be operated manually, or, alternatively, long ram hydraulic jack 90 may be connected to a hydraulic power source for powered operation. Other hydraulic, pneumatic, mechanical or electrical mechanisms may be used to provide the means for lifting the vehicle component, such as, for example, bottle jacks, pneumatic jacks, electrical motors, mechanical force multipliers, etc. For a manually-operated long ram hydraulic jack 90, a jack arm 96 is provided to raise support arm 60, and a release valve control 98 is provided to lower support arm 60. In the depicted embodiment, release valve control 98 is remotely mounted on support arm 60 proximate to articulated gripper 70. Flexible remote cable 97 connects release valve control 98 to release valve 99 of long ram hydraulic jack 90. In operation, sliding the release valve control 98 opens and closes release valve 99. Additionally, twisting the release valve control 98 locks the sliding control, and thus the release valve 99, in any desired position.

In a preferred embodiment, the articulated gripper 70 includes a proximal arm segment 71, fixedly attached to movable support arm 60, a medial arm segment 73, rotatably attached to proximal arm section 71 using hinge 72, a distal support segment 75, rotatably attached to medial arm segment 73 using hinge 74, a pair of opposing distal arm segments 77, 87, rotatably attached to distal support segment 75 using a pair of respective hinges 76, 86, and a pair of opposing distal support pads 79, 89, rotatably attached to distal arm segments 77, 87 (respectively) using a pair of respective hinges 78, 88. Distal support pads 79, 89 may be coated with protective, non-slip material, and cooperate with ratchet and strap assemblies 82, 84 to secure the vehicle component within the articulated gripper 70. Other methods and devices for securing the vehicle component within the articulated gripper 70 are also contemplated by the present invention.

Hinge 72 permits medial arm segment 73 to rotate about transverse axis B in a direction perpendicular to support arm 60, while hinge 74 permits distal support segment 75 to rotate about longitudinal axis C in a direction parallel to medial arm segment 73. Distal arm segments 77, 87 rotate about respective hinges 76, 86, and distal support pads 79, 89 rotate about respective hinges 78, 88, in order to accommodate different sized vehicle components. Additionally, distal support pads 79, 89 include hinges 81, 83 that allow the captured component to rotate freely about the axis D. In this manner, the captured component remains in a vertical orientation as it is raised or lowered by the lifting device 10. Accordingly, the articulated gripper 70 provides three degrees of rotational freedom about axes B, C and D, and when the lifting device 10 is disposed in a nominal orientation, axes B, C and D are orthogonal to one another.

Advantageously, articulated gripper 70 may include rotational locking mechanisms, such as, for example, locking hinges, to constrain rotation about axis B, axis C, and, optionally, axis D. In one embodiment, through-holes (not shown) are provided in proximal arm segment 71 and medial arm segment 73, proximate to hinge 72, to accommodate one or more pins. When the respective through-holes are aligned, the pin(s) may be placed therethrough to secure rotation about transverse axis B. Similarly, through-holes are provided in medial arm segment 73 and distal support segment 75, proximate to hinge 74, to accommodate one or more pins. When the respective through-holes are aligned, the pin(s) may be placed therethrough to secure rotation about longitudinal axis C. Rotational locking mechanisms may also be provided for hinges 76, 78, 86 and 88, in order to lock the distal arm segments 77, 87 at various ranges of motion, such as, for example, 30°, 45°, 90°, etc.

In a preferred embodiment, the medial arm segment 73 rotates about axis transverse B through ±45°, with locking points at 0° and ±45°. In another preferred embodiment, distal support segment 75 rotates about longitudinal axis C through 360°, with locking points every 90°. In a further preferred embodiment, distal support pads 79, 89 are free to rotate about axis D through 360°. Other ranges of motion and locking points are also contemplated by the present invention, such as, for example, a more expansive range of transverse rotation, a more limited range of longitudinal rotation, locking points every 10°, every 15°, every 30°, etc.

In further embodiments, the rotation about axis B and (or) axis C may be assisted by pneumatic, hydraulic, mechanical or electrical devices, such as electric motors. Additionally, locking mechanisms may be incorporated into these powered devices, or, alternatively, provided as one or more additional components. For example, distal arm segments 77, 87 and distal support pads 79, 89, and their respective hinges, may be replaced by pneumatic, hydraulic, mechanical, or electrical clamping devices.

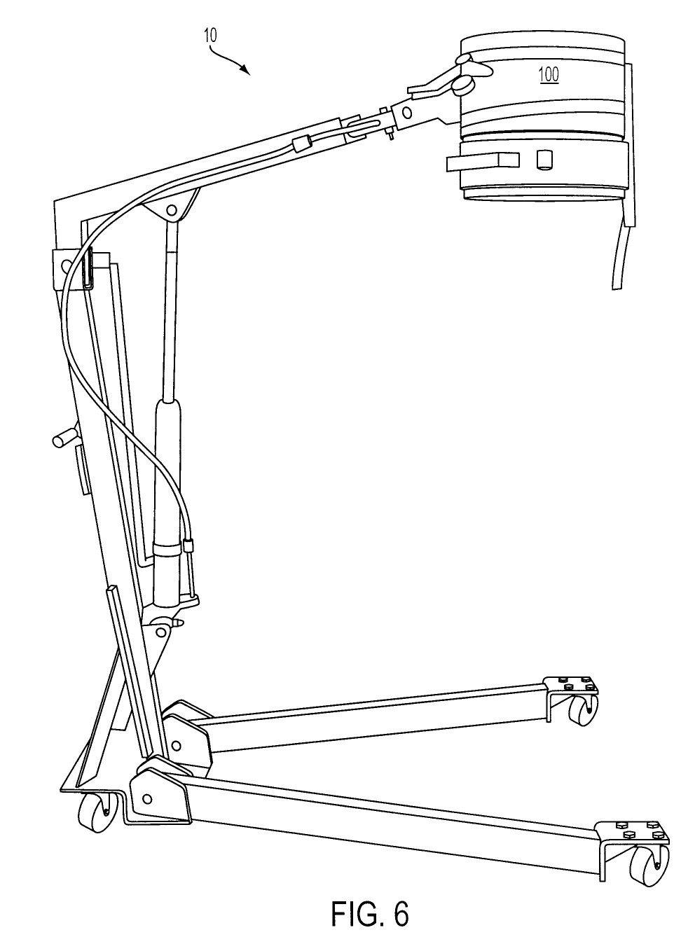

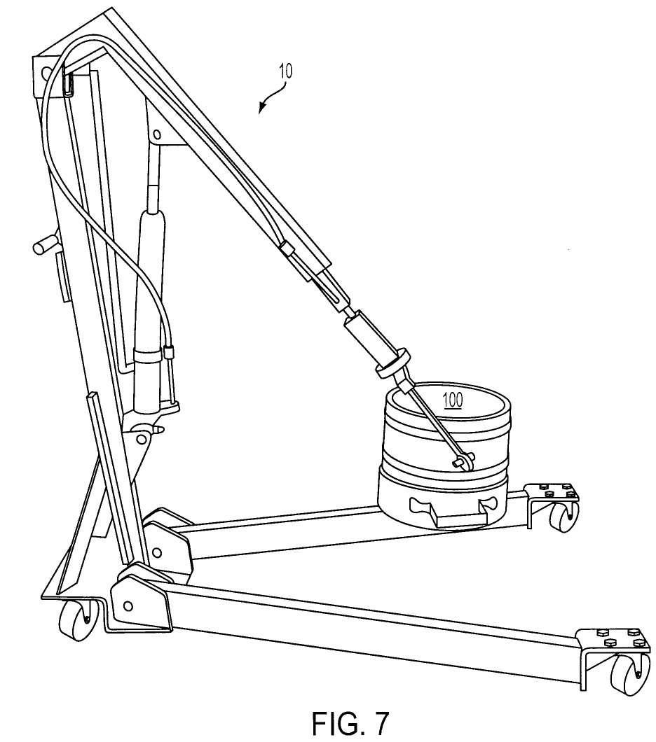

FIGS. 6 and 7 depict a lifting device 10 in raised and lowered positions, respectively, according to an embodiment of the present invention. Vehicle component 100 may be any appropriate component of the vehicle, such as, for example, a diesel particulate filter. In order to remove component 100 from the vehicle, the technician maneuvers the lifting device 10 to a position close to the vehicle and extends the support arm 60, by manipulating jack arm 96 of long arm hydraulic jack 90, such that the articulated gripper 70 is adjacent to the component 100. The ratchet and strap assemblies 82, 84 are arranged on, and attached to, component 100, which may need to be loosened somewhat prior to removal. Once the ratchet and strap assemblies are secured to component 100, and component 100 is disconnected from the vehicle, the lifting device 10 is maneuvered away from the vehicle. The technician then unlocks and slides remote valve control 98 to an open position, which opens control valve 99 and lowers the support arm 60, articulate gripper 70 and component 100. Once component 100 is resting on the ground, or some other suitable surface, ratchet and strap assemblies 82, 84 are removed. Generally, this process is followed, in reverse order, to install component 100 on the vehicle. As shown in FIG. 7, component 100 remains in a vertical position in the lowered position, due to the free rotation about axis D.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for raising and lowering a component of a vehicle for maintenance, comprising:
a base;
a plurality of legs attached to the base;
a fixed support arm attached to the base;
a movable support arm rotatably attached to the fixed support arm;
a long arm jack, attached to the fixed support arm and the movable support arm; and
an articulated gripper attached to an end of the movable support arm, the articulated gripper including:
a first member,
a second member attached to the first member via a first hinge;
a third member, attached to the second member via a second hinge, the third member including two opposing arms, each arm having a rotatable pad attached thereto via respective third hinges, and
a clamping member to secure the component to the pads.

2. The apparatus of claim 1, wherein the respective axes of rotation of the first, second and third hinges are orthogonal to one another when the articulated gripper is disposed in a nominal orientation.

3. The apparatus of claim 1, wherein each pad has an inner surface, coated with a non-skid material, to abut the component.

4. The apparatus of claim 1, wherein the first and second hinges are locking hinges.

5. The apparatus of claim 1, wherein the first and second members include a plurality of cooperating through-holes, and the first hinge is locked in one of a plurality of predetermined orientations using at least one pin disposed within a respective pair of aligned through-holes.

6. The apparatus of claim 1, wherein second and third members include a plurality of cooperating through-holes, and the second hinge is locked in one of a plurality of predetermined orientations using at least one pin disposed within a respective pair of aligned through-holes.

7. The apparatus of claim 1, wherein rotation about the first and second hinges is assisted by a pneumatic, hydraulic, mechanical or electrical device.

8. The apparatus of claim 1, wherein the clamping member includes at least one ratchet and strap assembly.

9. The apparatus of claim 1, wherein the clamping member includes at least one band clamp.

10. The apparatus of claim 1, wherein the clamping member is a pneumatic, hydraulic, mechanical or electrical clamping device.

11. The apparatus of claim 1, further comprising a remote valve control, coupled to the long arm jack, disposed on the movable support arm proximate to the articulated gripper.

12. An articulated gripper, comprising:
a first member,
a second member attached to the first member via a first hinge;
a third member, including:
a support segment attached to the second member via a second hinge, and
a pair of movable arm segments, attached to respective ends of the support segment, each arm segment having a rotatable pad attached thereto via respective third hinges; and
a clamping member to cooperate with the pads.

13. The gripper of claim 12, wherein the respective axes of rotation of the first, second and third hinges are orthogonal to one another when the first, second and third members are disposed in a nominal orientation.

14. The gripper of claim 12, wherein each pad has an inner surface, coated with a non-skid material, to abut the component.

15. The gripper of claim 12, wherein the first and second hinges are locking hinges.

16. The gripper of claim 12, wherein first and second members include a plurality of cooperating through-holes, and the first hinge is locked in one of a plurality of predetermined orientations using at least one pin disposed within a respective pair of aligned through-holes.

17. The gripper of claim 12, wherein second and third members include a plurality of cooperating through-holes, and the second hinge is locked in one of a plurality of predetermined orientations using at least one pin disposed within a respective pair of aligned through-holes.

18. The gripper of claim 12, wherein the clamping member includes at least one ratchet and strap assembly.

19. The gripper of claim 12, wherein the clamping member includes at least one band clamp.

20. An apparatus for raising and lowering a component of a vehicle for maintenance, comprising:
a frame having a base, a plurality of legs attached to the base, a fixed support arm attached to the base and a movable support arm rotatably attached to the fixed support arm;
a means for raising and lowering the movable support arm, attached to the fixed support arm and the movable support arm; and
a means for gripping the component, attached to an end of the movable support arm, having three rotational degrees of freedom.
